(19) United States
(12) Patent Application Publication
(10) Pub. No.: US 2011/0282609 A1
(43) Pub. Date: Nov. 17, 2011

(54) METHOD AND SYSTEM FOR MAGNETIC INDUCTION TOMOGRAPHY

(75) Inventors: Hui Liu, Shanghai (CN); Dayu Chen, Shanghai (CN)

(73) Assignee: KONINKLIJKE PHILIPS ELECTRONICS N.V., EINDHOVEN (NL)

(21) Appl. No.: 13/142,395

(22) PCT Filed: Dec. 11, 2009
(86) PCT No.: PCT/IB09/55676

§ 371 Date: Jun. 27, 2011

(30) Foreign Application Priority Data
Dec. 30, 2008 (CN) 200810190252.X

(51) Int. Cl. G06F 19/00

(52) U.S. Cl. 702/65

(57) ABSTRACT

This invention relates to a method and apparatus for estimating artifacts in the image reconstruction of an object of interest (101). The inventive apparatus comprises a coil arrangement (105) comprising at least one transmitting coil (109, 109′) for generating a primary magnetic field to be applied to the object of interest (101), and at least one measurement coil (110, 110′) for measuring electrical signals induced by a secondary magnetic field, the secondary magnetic field being generated by the object of interest in response to the primary magnetic field; motion sensing means (112, 114, 112′, 114; 312, 314, 312′, 314′) for sensing a relative motion between the object of interest (101) and the coil arrangement (105) and generating a trigger signal when the relative motion occurs; and a processor (125) for calculating, in response to the trigger signal, a change of the conductivity distribution of the object of interest, based on the electrical signals measured before and after the relative motion, the change of the conductivity distribution representing artifacts caused by the relative motion.

### FIELD OF THE INVENTION

The invention relates to magnetic induction tomography, in particular to a method and system for improving the imaging quality of magnetic induction tomography by estimating and removing artifacts.

### BACKGROUND OF THE INVENTION

Magnetic induction tomography (MIT) is a non-invasive and contactless imaging technique with applications in industry and medical imaging. In contrast to other electrical imaging techniques, MIT does not require direct contact of the sensors with the object of interest for imaging. MIT is used to reconstruct the spatial distribution of the passive electrical properties inside the object of interest, for example, conductivity σ.

Prior art patent application WO2007072343 discloses a magnetic induction tomography system for studying the electromagnetic properties of an object. The system comprises: one or more generator coils adapted for generating a primary magnetic field, said primary magnetic field inducing an eddy current in the object; one or more sensor coils adapted for sensing a secondary magnetic field, said secondary magnetic field being generated as a result of said eddy current; and means for providing a relative movement between one or more generator coils and/or one or more sensor coils, on the one hand, and the object to be studied, on the other hand.

A technical challenge for hardware design of a MIT system relates to removing artifacts caused by relative motion between the coil arrangement and an object to be imaged. In medical applications, most tissues have a low conductivity and thus give a small electronic signal, for example, the phase change in the sensed magnetic field due to the secondary magnetic field is very small, usually in the order of milli-degrees and thus difficult to detect. On the other hand, for medical applications, such as long-term patient monitoring, it is impossible to keep the object to be monitored immobile.

### SUMMARY OF THE INVENTION

An object of this invention is to provide an apparatus for image reconstruction with improved imaging quality.

According to an aspect of the invention, there is provided an apparatus for estimating artifacts in the image reconstruction of an object of interest, said apparatus comprising:
a coil arrangement comprising at least one transmitting coil for generating a primary magnetic field to be applied to the object of interest, and at least one measurement coil for measuring electrical signals induced by a secondary magnetic field, the secondary magnetic field being generated by the object of interest in response to the primary magnetic field;
motion sensing means for sensing a relative motion between the object of interest and the coil arrangement and generating a trigger signal when the relative motion occurs; and
a processor for calculating, in response to the trigger signal, a change of the conductivity distribution of the object of interest, based on the electrical signals measured before and after the relative motion, the change of the conductivity distribution representing artifacts caused by the relative motion.

By sensing the relative motion between the object of interest and the coil arrangement and calculating the signal difference caused by the relative motion for image reconstruction, the artifacts caused by the relative motion can be reduced dramatically.

In an embodiment, the motion sensing means comprises at least one magnet for generating a magnetic field, and at least one giant magneto resistance sensor for sensing a change of the magnetic field caused by the movement of the at least one magnet, the at least one magnet being attached to the object of interest and the at least one giant magneto resistance sensor being attached to the coil arrangement or support thereof.

As the magnet and the giant magneto resistance sensor are attached to respectively the object of interest and the coil arrangement or support thereof, the relative motion between the object of interest and the coil arrangement can be sensed without limiting the free movement of the object of interest.

In another embodiment, the apparatus further comprises at least one temperature sensor for measuring the temperature drift in the coil arrangement, wherein the processor is further arranged for estimating a signal drift of measured electrical signals, based on the temperature drift, and calculating an additional change of the conductivity distribution of the object of interest, based on the signal drift, the additional change of the conductivity distribution representing artifacts caused by the temperature drift.

By measuring temperature drift and estimating the corresponding signal drift in measurements, the artifacts caused by the temperature drift can be reduced, resulting in improved imaging quality

According to an aspect of the invention, there is provided a method of estimating artifacts in the image reconstruction of an object of interest, the method comprising the following steps:
generating a primary magnetic field to be applied to the object of interest by at least one transmitting coil;
measuring electrical signals induced by a secondary magnetic field by at least one measurement coil, the secondary magnetic field being generated by the object of interest in response to the primary magnetic field;
sensing a relative motion between the object of interest and the coil arrangement comprising the at least one transmitting coil and the at least one measurement coil;
generating a trigger signal when the relative motion occurs; and
calculating a change of the conductivity distribution of the object of interest, in response to the trigger signal, based on the electrical signals measured before and after the relative motion, the change of the conductivity distribution representing artifacts caused by the relative motion.

Detailed explanations and other aspects of the invention are given below.

### DESCRIPTION OF THE DRAWINGS

The above and other objects and features of the present invention will become more apparent from the following detailed description considered in connection with the accompanying drawings, in which:

FIG. 1 shows a first embodiment of the apparatus for estimating artifacts in the image reconstruction in accordance with the invention.

FIGS. 2 (a) and 2(b) show the relationship between the relative motion and measured electrical signals that is obtained in experiments.

FIG. 3 shows a second embodiment of the apparatus for estimating artifacts in the image reconstruction in accordance with the invention.

FIG. 4 shows a third embodiment of the apparatus for estimating artifacts in the image reconstruction in accordance with the invention.

FIGS. 5 (a) and 5(b) show the relationship between thermal drift and measured signals in an open laboratory environment.

FIGS. 6 (a) and 6(b) show the relationship between thermal drift and measured signals in the case of external thermal interference.

FIG. 7 is a flowchart of the method of estimating artifacts in the image reconstruction in accordance with the invention.

The same reference numerals are used to denote similar parts throughout the Figures.

### DETAILED DESCRIPTION

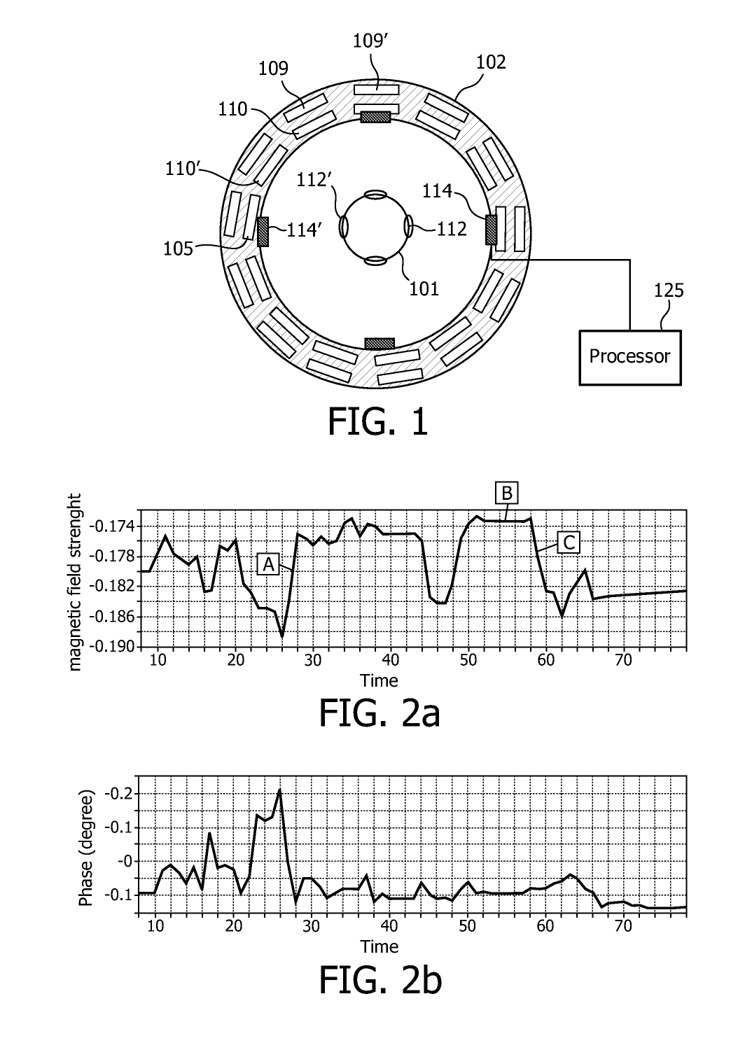

FIG. 1 shows a first embodiment of the apparatus 100 for estimating motion artifacts in the image reconstruction in accordance with the invention.

The apparatus 100 comprises a coil arrangement 105, which comprises at least one transmitting coil 109, 109′ for generating a primary magnetic field to be applied to the object of interest 101. The primary magnetic field induces an eddy current in an object of interest 101. The object of interest 101 can be the head of a human being or a block of conductive material.

The coil arrangement 105 further comprises at least one measurement coil 110, 110′ for measuring electrical signals induced by a secondary magnetic field. The secondary magnetic field is generated by the object of interest in response to the primary magnetic field. In particular, the second magnetic field is generated by the eddy current in the object of interest that is induced by the primary magnetic field.

The coil arrangement 105 can be situated on a support 102.

The apparatus 100 further comprises motion sensing means 112, 114, 112′ 114′ for sensing a relative motion between the object of interest 101 and the coil arrangement 105. The motion sensing means generates a trigger signal when the relative motion occurs, for example when the sensed relative motion exceeds a predefined scope.

The apparatus 100 further comprises a processor 125 for calculating, in response to the trigger signal, a change of the conductivity distribution of the object of interest, based on the electrical signals measured before and after the relative motion, the change of the conductivity distribution representing artifacts caused by the relative motion.

The calculation of a change of the conductivity distribution of an object of interest follows the image reconstruction theory, for example, the calculation can follow the theory described in the prior art document “Image reconstruction approaches for Philips magnetic induction tomography”, M. Vauhkonen, M. Hamsch and C. H. Igney, ICEBI 2007, IFMBE Proceedings 17, pp. 468-471, 2007. According to the following equation, e.g., the equation (8) in the mentioned prior art, a change of the conductivity distribution can be calculated as:

Δσ=(J^{T}W^{T}WJ+αL^{T}L)⁻¹(J^{T}W^{T}WΔVᵢ)

where W is a weighting matrix, α is a regularization parameter and L is a regularization matrix, J is the imaginary part of the complex Jacobian matrix, ΔVᵢ is the difference voltage induced on the measurement coil before and after the relative motion. The measured difference voltage corresponds to a change of the conductivity distribution, which indicates artifacts caused by the relative motion. The change of the conductivity distribution caused by the relative motion can be reduced in the subsequent calculation of the conductivity distribution, thereby removing artifacts in the image reconstructions.

In a practical implementation, the difference voltage can be derived from the magnitude of measured voltages and the phase offset between two measured voltages. The calculation of the conductivity distribution can be advantageously implemented by means of a computer program.

In an embodiment, the motion sensing means comprises at least one magnet 112, 112′ for generating a magnetic field, and at least one giant magneto resistance sensor 114, 114′ for sensing a change of the magnetic field caused by the movement of the at least one magnet, the at least one magnet 112, 112′ being attached to the object of interest 101 and the at least one giant magneto resistance sensor 114, 114′ being attached to the coil arrangement 105 or the support 102 thereof.

Advantageously, the magnet 112, 112′ is a NiFeB hard magnet.

FIGS. 2(a) and 2(b) show the relationship between the relative motion and measured electrical signals that is obtained from experiments.

Referring to FIGS. 2(a) and 2(b), it is observed that the measured phase of voltage induced in the measurement coil changes with the relative motion between the object of interest and the coil arrangement. In FIG. 2 (a), A indicates a rotation movement, B indicates no movement, and C indicates a transverse movement; accordingly, it can be observed in FIG. 2(b) that the phase corresponding to points A and B changes. However, the phase change is non-linear to the relative movement, because the artificial conductivity change caused by the motion is non-linear.

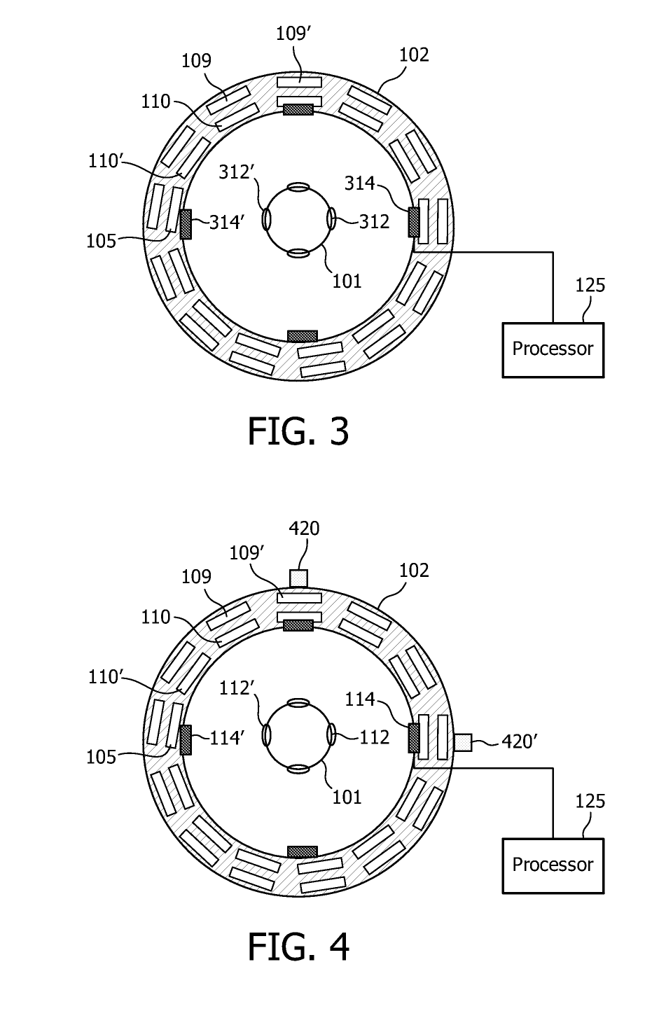

FIG. 3 shows a second embodiment of the apparatus for estimating artifacts in the image reconstruction in accordance with the invention.

In this embodiment, the only difference with respect to the embodiment shown in FIG. 1 is the motion sensing means, which comprises at least one light source 312, 312′ for generating a light beam, and at least one optical sensor 314, 314′ for sensing a change of the light beam caused by the movement of the at least one light source. The at least one light source 312,312′ is attached to the object of interest 101 and the at least optical sensor 314,314′ is attached to the coil arrangement 105 or support 102 thereof.

FIG. 4 shows a third embodiment of the apparatus for estimating artifacts in the image reconstruction in accordance with the invention.

Referring to FIG. 4, the apparatus further comprises at least one temperature sensor 420, 420′ for monitoring the temperature drift in the system. Advantageously the at least one temperature sensor is situated close to the coil arrangement, preferably, on the printed circuit board holding the coil arrangement.

The processor is further arranged for estimating a signal drift of measured electrical signals, based on the temperature drift, and calculating an additional change of the conductivity distribution of the object of interest, based on the signal drift. The signal drift corresponds to an additional change of the conductivity distribution, which indicates artifacts caused by the temperature drift.

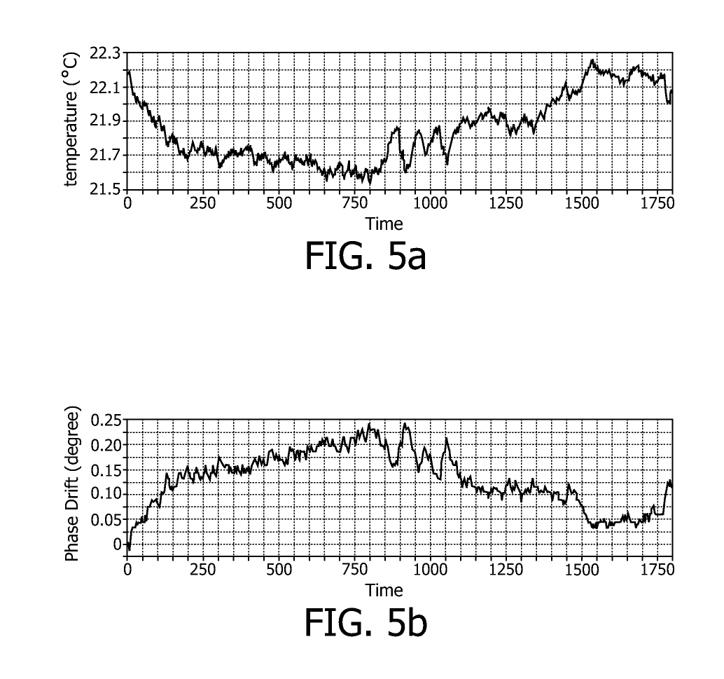

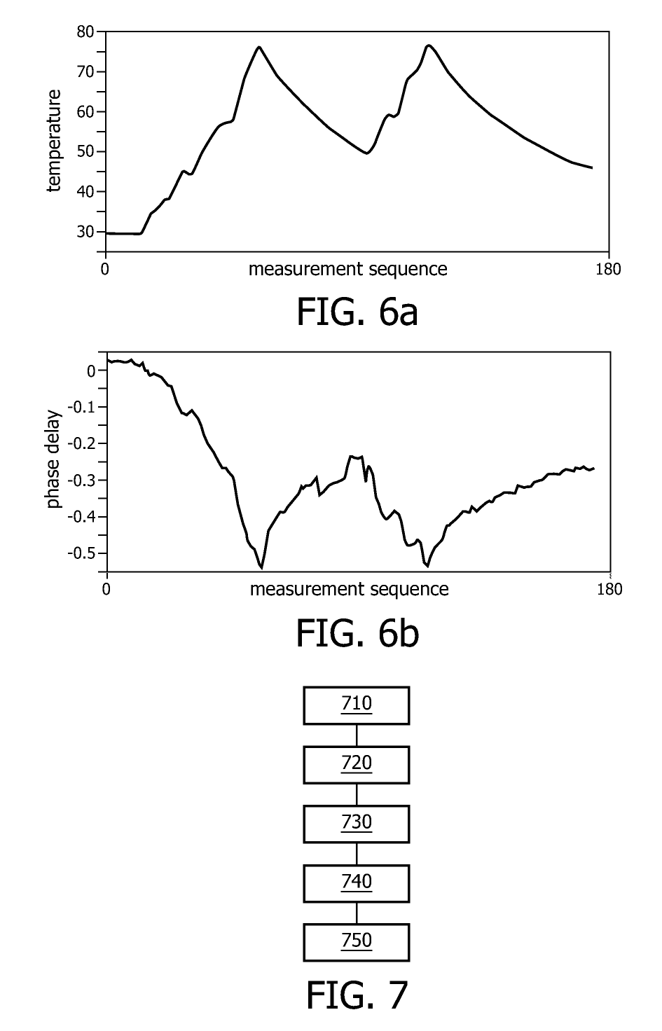

There are many ways to estimate signal drift of measured electrical signals, for example, by estimating the phase drift of the voltage induced in the measurement coil, based on the known relationship between thermal drift and measured phase change. The details can be explained hereinbelow in combination with the considerations of FIG. 5 and FIG. 6.

FIGS. 5 (a) and 5(b) show the relationship between thermal drift and measured signals in an open laboratory environment.

FIGS. 6 (a) and 6(b) show the relationship between thermal drift and measured signals with external thermal interference.

Referring to FIGS. 5 and 6, it is observed that the absolute correlation coefficient between temperature change and phase change is as high as 0.97-0.98. Once the relationship between thermal drift and measured phase offset is known, one can determine the phase offset according to the thermal drift, based on a linear or polynomial fitting method.

FIG. 7 is a flowchart of the method of estimating artifacts in the image reconstruction in accordance with the invention.

Referring to FIG. 7, the method comprises a step 710 of generating a primary magnetic field to be applied to the object of interest by at least one transmitting coil. The primary magnetic field induces eddy currents in the object of interest.

The method further comprises a step 720 of measuring electrical signals induced by a secondary magnetic field by at least one measurement coil. The secondary magnetic field is generated by the object of interest in response to the primary magnetic field. Particularly the secondary magnetic field is generated by the eddy currents in the object of interest.

The method further comprises a step 730 of sensing a relative motion between the object of interest and the coil arrangement comprising the at least one transmitting coil and measurement coil.

The method further comprises a step 740 of generating a trigger signal when the relative motion occurs.

The method further comprises a step 750 of calculating a change of the conductivity distribution of the object of interest, in response to the trigger signal, based on the electrical signals measured before and after the relative motion. The change of the conductivity distribution represents artifacts caused by the relative motion, and can be reduced in reconstructed images of the object of interest, resulting in improved quality of image reconstruction.

In an embodiment, the sensing step 730 comprises a sub-step of generating a magnetic field by at least one magnet, and a sub-step of sensing a change of the magnetic field caused by the relative motion of the at least one magnet by at least one giant magneto resistance sensor.

Advantageously the at least one magnet is a NiFeB hard magnet and the at least one magnet is attached to the object of interest and the at least one giant magneto resistance sensor is attached to the coil arrangement or a support holding the coil arrangement.

In another embodiment, the sensing step 730 comprises a sub-step of generating a light beam by at least one light source, and a sub-step of sensing a change of the light beam caused by the relative motion of the at least one light source.

Advantageously the at least one light source is attached to the object of interest and the at least optical sensor is attached to the coil arrangement or support thereof.

In another further embodiment, the method further comprises steps of measuring the temperature drift in the coil arrangement, estimating a signal drift of measured electrical signals, based on the temperature drift; and calculating an additional change of the conductivity distribution of the object of interest, based on the signal drift.

The additional change of the conductivity distribution represents artifacts caused by the temperature drift, and can be reduced in reconstructed images of the object of interest, resulting in a further improved quality of image reconstruction.

It should be noted that the above-mentioned embodiments illustrate rather than limit the invention and that those skilled in the art will be able to design alternative embodiments without departing from the scope of the appended claims. In the claims, any reference signs placed between parentheses shall not be construed as limiting the claim. The word “comprising” does not exclude the presence of elements or steps not listed in a claim or in the description. The word “a” or “an” preceding an element does not exclude the presence of a plurality of such elements. In the apparatus claims enumerating several units, several of these units can be embodied by one and the same item of hardware or software. The usage of the words first, second and third, et cetera, does not indicate any ordering. These words are to be interpreted as names.

1. An apparatus for estimating artifacts in the image reconstruction of an object of interest (101), said apparatus comprising:
a coil arrangement (105) comprising at least one transmitting coil (109, 109′) for generating a primary magnetic field to be applied to the object of interest (101), and at least one measurement coil (110, 110′) for measuring electrical signals induced by a secondary magnetic field, the secondary magnetic field being generated by the object of interest in response to the primary magnetic field;
motion sensing means (112, 114, 112′, 114′; 312, 314, 312′, 314′) for sensing a relative motion between the object of interest (101) and the coil arrangement (105) and generating a trigger signal when the relative motion occurs; and
a processor (125) for calculating, in response to the trigger signal, a change of the conductivity distribution of the object of interest, based on the electrical signals measured before and after the relative motion, the change of the conductivity distribution representing artifacts caused by the relative motion.

2. An apparatus as claimed in claim 1, wherein the motion sensing means comprises at least one magnet (112, 112′) for generating a magnetic field, and at least one giant magneto resistance sensor (114, 114′) for sensing a change of the magnetic field caused by the relative motion of the at least one magnet, the at least one magnet (112, 112′) being attached to the object of interest (101) and the at least one giant magneto resistance sensor (114, 114′) being attached to the coil arrangement (105) or support (102) thereof.

3. An apparatus as claimed in claim 2, wherein the at least one magnet (112, 112′) is a NiFeB hard magnet.

4. An apparatus as claimed in claim 1, wherein the motion sensing means comprises at least one light source (312, 312′) for generating a light beam, and at least one optical sensor (314, 314′) for sensing a change of the light beam caused by the relative motion of the at least one light source, the at least one light source (312, 312′) being attached to the object of interest (101) and the at least optical sensor (314, 314′) being attached to the coil arrangement (105) or support (102) thereof.

5. An apparatus as claimed in claim 1, further comprising:
at least one temperature sensor (420, 420′) for measuring the temperature drift in the coil arrangement;
wherein the processor (125) is further arranged for estimating a signal drift of measured electrical signals, based on the temperature drift, and calculating an additional change of the conductivity distribution of the object of the interest, based on the signal drift, the additional change of the conductivity distribution representing artifacts caused by the temperature drift.

6. A method of estimating artifacts in the image reconstruction of an object of interest, the method comprising the following steps:
generating (710) a primary magnetic field to be applied to the object of interest by at least one transmitting coil;
measuring (720) electrical signals induced by a secondary magnetic field by at least one measurement coil, the secondary magnetic field being generated by the object of interest in response to the primary magnetic field;
sensing (730) a relative motion between the object of interest and a coil arrangement comprising the at least one transmitting coil and measurement coil;
generating (740) a trigger signal when the relative motion occurs; and
calculating (750) a change of the conductivity distribution of the object of interest, in response to the trigger signal, based on the electrical signals measured before and after the relative motion, the change of the conductivity distribution representing artifacts caused by the relative motion.

7. An apparatus as claimed in claim 6, wherein the sensing step (730) comprises:
generating a magnetic field by at least one magnet; and
sensing a change of the magnetic field caused by the relative motion of the at least one magnet by at least one giant magneto resistance sensor,
wherein the at least one magnet is attached to the object of interest and the at least one giant magneto resistance sensor is attached to the coil arrangement or support thereof.

8. A method as claimed in claim 7, wherein the at least one magnet is a NiFeB hard magnet.

9. A method as claimed in claim 6, furthering comprising:
generating a light beam by at least one light source; and
sensing a change of the light beam caused by the relative motion of the at least one light source,
wherein the at least one light source is attached to the object of interest and the at least one optical sensor is attached to the coil arrangement or support thereof.

10. A method as claimed in claim 6, further comprising the steps of:
measuring the temperature drift in the coil arrangement;
estimating a signal drift of measured electrical signals, based on the temperature drift; and
calculating an additional change of the conductivity distribution of the object of interest, based on the signal drift, the additional change of the conductivity distribution representing artifacts caused by the temperature drift.
